(19) United States
(12) Patent Application Publication
(10) Pub. No.: US 2025/0126108 A1
(43) Pub. Date: Apr. 17, 2025

(54) Secure File Sharing Between Enrolled Users

(71) Applicant: Omnissa, LLC, Mountain View, CA (US)

(72) Inventors: RAMANANDAN NAMBANNOR KUNNATH, Bangalore (IN); ROHIT PRADEEP SHETTY, Bangalore (IN); SIJO POULOSE, Bangalore (IN)

(21) Appl. No.: 18/607,366

(22) Filed: Mar. 15, 2024

(30) Foreign Application Priority Data
Oct. 11, 2023 (IN) 202341068362

(51) Int. Cl. H04L 9/40

(52) U.S. Cl. CPC H04L 63/0823; H04L 63/0428

(57) ABSTRACT

Disclosed are various approaches for sharing secure files between users belonging to the same enterprise. To begin, a computing device can identify a recipient device for a secure file transfer. Then, the computing device can verify an enrollment status of the recipient device with an enterprise. Next, the computing device can verify a compliance level of the recipient device. Based at least in part on a successful verification of the enrollment status and the compliance level, the computing device can transfer one or more secure files to the recipient device.

### CROSS-REFERENCES

This application claims the benefit of Indian patent application Ser. No. 20/234,1068362, entitled “SECURE FILE SHARING BETWEEN ENROLLED USERS,” filed on Oct. 11, 2023, of which is hereby incorporated by reference in its entirety.

### BACKGROUND

Secure file sharing is important to a number of enterprises and organizations. The ability to share files facilitates collaboration within an enterprise as well as communications and business with other enterprises. In addition, most enterprises typically prefer to have their sensitive internal documents secure. Thus, the ability to share highly confidential files safely is important to reduce the risk of fraud, cyber leaks, and other security incidents. In addition, attempts to share secure files with limited connectivity can open the door to security risks.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart illustrating one example of functionality implemented as portions of an application executed in the network environment of FIG. 1 according to various examples of the present disclosure.

FIG. 3 is a sequence diagram illustrating one example of the interactions between the components of the network diagram of FIG. 2 according to various embodiments of the present disclosure.

### DETAILED DESCRIPTION

Disclosed are various approaches for sharing secure files between users belonging to the same enterprise. Often, users belonging to the same enterprise, such as coworkers or fellow members of an organization, wish to share secure files when they are offline or have limited connectivity. When connected over a secure network, users have various options to share secure files. However, when a secure network is not available, it can be difficult or impossible to share secure files without compromising security.

For example, if two employees of the same enterprise are in an airport with limited or no secure connectivity, these employees cannot utilize bandwidth intensive sharing options such as email or uploading to, and subsequently downloading from, a cloud service. Thus, despite being in close proximity to one another, these employees are unable to share secure files over secure channels. Facing such a difficulty can result in employees using unsecured means to share files such as taking a picture of secure file with a phone, which can lead to data security breaches since the picture file is not secure, and the phone with which the picture was captured may not be secure either.

As such, various embodiments of the present disclosure are directed to systems and methods for peer-to-peer secure file sharing between users of the same enterprise. The systems and methods described herein can detect and verify whether nearby end users belong to the same enterprise or not and whether their respective devices meet the requisite security compliance requirements for the particular files being transferred. To verify that both devices or users belong to the same enterprise, an application for sharing and transferring files on the client device can be configured to obtain and verify certificates of another client device in order to determine the identity of the device. In addition, the application can be configured to check a security compliance level of the other client device to verify that the client device is cleared to receive the secure files. In some situations, each file stored on a client device can have a security level. While verifying the security compliance level of a potential recipient device, the application can be configured to ensure that the recipient device has the requisite security compliance level corresponding to the security level of the files intended for sharing.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

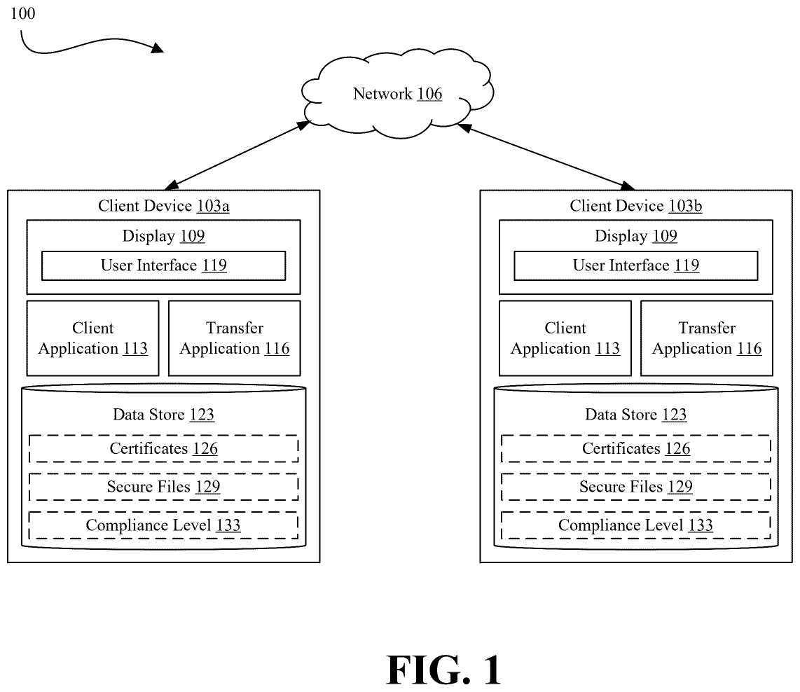

With reference to FIG. 1, shown is a network environment 100 according to various embodiments. The network environment 100 can include one or more client devices 103 which can be in data communication with each other via a network 106.

The network 106 can include wide area networks (WANs), local area networks (LANs), personal area networks (PANs), or a combination thereof. These networks 106 can include wired or wireless components or a combination thereof. Wired networks can include Ethernet networks, cable networks, fiber optic networks, and telephone networks such as dialup, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 106 can also include a combination of two or more networks 106. Examples of networks 106 can include the Internet, intranets, extranets, virtual private networks (VPNs), and similar networks.

The client devices 103a and 103b are representative of a plurality of client devices 103 that can be coupled to the network 106. Each client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays 109, such as liquid crystal displays (LCDs), gas plasma-based flat panel displays, organic light emitting diode (OLED) displays, electrophoretic ink (“E-ink”) displays, projectors, or other types of display devices. In some instances, the display 109 can be a component of the client device 103 or can be connected to the client device 103 through a wired or wireless connection.

Each client device 103 can execute various applications such as a client application 113, a transfer application 116, or other applications. The client application 113 can be executed in a client device 103 to access network content served up by a computing environment or other servers, thereby rendering a user interface 119 on the display 109. To this end, the client application 113 can include a browser, a dedicated application, or other executable, and the user interface 119 can include a network page, an application screen, or other user mechanism for obtaining user input. Each client device 103 can be configured to execute applications beyond the client application 113, such as social networking applications, camera applications, word processors, spreadsheets, or other applications.

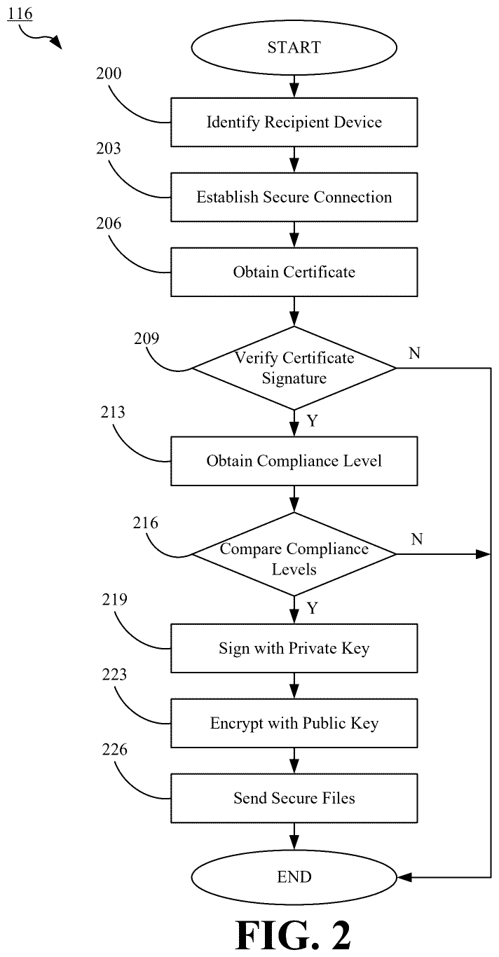

Each client device 103 can be configured to execute a transfer application 116. As described further in the discussion of FIG. 2, the transfer application 116 of a first client device 103a can be executed to identify a potential recipient client device 103b and establish a secure connection over the network 106. Additionally, the transfer application 116 can be executed to verify the identity of the recipient client device 103b and whether the recipient client device 103b belongs to a user of the same enterprise as the user of the first client device 103a. In some embodiments, the transfer application 116 can be executed to verify the security compliance of the recipient client device 103b before transferring files.

Also, various data are stored in a data store 123 that is accessible to the client device 103. The data store 123 can be representative of a plurality of data stores 123, which can include relational databases or non-relational databases such as object-oriented databases, hierarchical databases, hash tables or similar key-value data stores, as well as other data storage applications or data structures. Moreover, combinations of these databases, data storage applications, and/or data structures can be used together to provide a single, logical, data store. The data stored in the computing environment data store 123 is associated with the operation of the various applications or functional entities described below. This data can include certificates 126, secure files 129, compliance levels 133, and potentially other data.

The certificates 126 can be representative of digital files which can be used to verify the identity of a client device 103. The certificates 126 can include a digital signature as well as information about a public key associated with the client device 103, the client device 103, the user of the client device 103, and the enterprise associated with the client device 103 as well as potentially other information. The certificates 126 can be part of a certificate chain which is traceable to a root certificate. Certificates 126 can be used to determine the source of the client device 103 and whether or not the source is trustworthy.

The secure files 129 can be representative of text documents, photos, records, visual/audio recordings, programs, or other types of files. The secure files 129 can include sensitive or proprietary data which an enterprise or user does not wish to share publicly. The secure files 129 can be encrypted on the client device 103 or can be stored in an unencrypted state.

Compliance levels 133 can be representative of one or more different security classifications. Each client device 103 can have a compliance level 133 which can correspond to a plurality of security settings and configurations of the device. Additionally, each secure file 129 can be associated with a different compliance level 133 depending on the importance of the file. For example, a compliance level 133 could be a security classification of “Normal,” “Secure,” or “Highly Secure,” with each level corresponding to a different set of device settings, such as network restrictions, passcodes, multi-factor authentication measures, or other security measures. Thus, a secure file 129 which has a compliance level 133 of “Secure” can require a client device 103 to have a compliance level of “Secure” or higher before the client device 103 can access the secure file 129. The compliance level 133 can apply to a client device 103 or the user of said client device 103. Various data from the client device 103 or about the user, such as compliance history, event history, and the compliance levels 133 of the most commonly paired devices, as well as potentially other data, can impact the compliance level 133 of the client device 103.

Next, a general description of the operation of the various components of the network environment 100 is provided. To begin, a user of a first client device 103a can put the device in a transfer mode, enabling the transfer application 116 to search for other devices. Once a device has been found, the transfer application 116 of the first client device 103a can identify and communicate with the transfer application 116 of another client device 103b for sharing and transferring files. Once communication has been established between the client devices 103, the transfer applications 116 of the client devices 103 can be configured to obtain and verify certificates from each other in order to verify that both client devices 103 are associated with the same enterprise or organization. In some embodiments, once the client devices 103 have been verified, a user of the first client device 103a can initiate a send request to send a secure file 129 to a recipient client device 103b. The transfer applications 116 can communicate to check and verify the compliance level 133 of each device and the correspondence to the compliance level 133 of the secure file 129 which is to be transferred. After compliance is verified, the transfer application 116 can be executed to encrypt the secure files 129 and transfer them to the other client device 103.

Moving next to FIG. 2, shown is a flowchart that provides one example of the operation of a portion of the transfer application 116 according to various embodiments. It is understood that the flowchart of FIG. 2 provides merely an example of the many types of function arrangements that can be employed to implement the operation of the portion of the transfer application 116 as described herein. As an alternative, the flowchart of FIG. 2 can be viewed as depicting an example of elements of a method implemented in the network environment 100 (FIG. 1) according to one or more embodiments.

Beginning with block 200, the transfer application 116 of a first client device 103a can be executed to identify a recipient client device 103b. The transfer application 116 can utilize different hardware and software on the first client device 103a in order to search for devices. In some embodiments, the transfer application 116 can send a broadcast over the network 106 and receive a response signal from a nearby recipient client device 103b. According to various examples, the transfer application 116 can identify a recipient client device 103b in response to a signal from another application, the user interface 119, or another system or service in the network environment 100. In some embodiments, the transfer application 116 can send a notification to the user interface 119 of the first client device 103a, the recipient client device 103b, or another application, system, or service in the network environment 100 once a recipient client device 103b has been identified.

At block 203, the transfer application 116 can establish a secure connection with a recipient client device 103b. The secure connection can be made between client devices 103 over the network 106. In some examples, the transfer application 116 can establish a secure connection with the transfer application 116 of the recipient client device 103b identified at block 200. In some embodiments, the transfer application 116 can establish a secure connection with another application, system, or service in the network environment 100. According to various examples, once a secure connection has been established, the transfer application 116 can send a notification of successful connection to the user interface 119 of the first client device 103a, the recipient client device 103b, or another application, system, or service in the network environment 100.

At block 206, the transfer application 116 can obtain a certificate 126 from the recipient client device 103b. The transfer application 116 can obtain the certificate 126 from the recipient client device 103b over the secure connection established at block 203. In some embodiments, the transfer application 116 sends a certificate request to the recipient client device 103b and receives the certificate 126 in response to the certificate request. In some embodiments, the transfer application 116 obtains the certificate chain from the recipient client device 103b. According to various examples, the transfer application 116 can send a certificate-received notification to the user interface 119 of the first client device 103a, the recipient client device 103b, or another application, system, or service in the network environment 100.

At block 209, the transfer application 116 can verify the certificate signature from the certificate 126 obtained at block 206. The transfer application 116 can determine the signature from the certificate 126 obtained at block 206 and verify the signature of the certificate 126 based at least in part on a root certificate 126 which corresponds to the certificate obtained from the recipient client device 103b. In some embodiments, the transfer application 116 can compare the signature of the certificate 126 obtained from the recipient client device 103b to the certificate 126 of the first client device 103a which hosts the transfer application 116. The transfer application 116 can verify that the recipient client device 103b is enrolled with the same enterprise as the first client device 103a based at least in part on the certificate obtained at block 209. According to some examples, if the certificate signature does not identify a recipient client device 103b enrolled with the same enterprise as the first client device 103a, or the transfer application 116 otherwise fails to verify the certificate signature, the transfer application 116 can end the connection between the first client device 103a and the recipient client device 103b. In these examples, when the connection ends, the flowchart of FIG. 2 can end. In some examples, the transfer application 116 can verify the certificate signature and thereby, the enrollment status of the recipient client device 103b and proceed to the next block. In some embodiments, if the root certificate corresponds to an enterprise with which the first client device 103a is enrolled, the verification is successful. In some examples where verification is successful, the transfer application 116 can send a verification successful notification to a user interface 119 on the first client device 103a, or the recipient client device 103b, or another application, system, or service in the network environment 100.

Next, at block 213, the transfer application 116 can obtain a compliance level 133 from the recipient client device 103b. The transfer application 116 can send a compliance level request to the recipient client device 103b and receive the compliance level 133 data from the recipient client device 103b in response. In some examples, the transfer application 116 of the first client device 103a communicates with the transfer application 116 of the recipient client device 103b to obtain the compliance level 133. The transfer application 116 can obtain the compliance level 133 based at least in part on a successful verification of the enrollment status, and certificate signatures, of the recipient client device 103b. According to various examples, the transfer application 116 can send a compliance level-obtained notification to a user interface 119 on the first client device 103a, or the recipient client device 103b, or another application, system, or service in the network environment 100.

At block 216, the transfer application 116 can compare the compliance level 133 received at block 213 with the compliance level 133 of the first client device 103a. In some embodiments, the transfer application 116 can compare the compliance level 133 of the recipient client device 103b with the compliance level 133 of the secure files 129 which are to be transferred. According to various examples, if the compliance levels 133 of the recipient client device 103b and the secure files 129 match, then the transfer application 116 can proceed to the next step. In some examples, where the compliance levels 133 do not match, the transfer application 116 can determine if the compliance level 133 of the recipient client device 103b is higher or lower than the compliance level 133 of the secure files 129. In some embodiments, when the compliance level 133 of the recipient client device 103b is higher than that of the secure files 129, the transfer application 116 can verify the compliance level and proceed to the next step. In some embodiments, when the compliance level 133 of the recipient client device 103b is lower than the compliance level 133 of the secure files 129, the transfer application 116 can stop the transfer and the flowchart of FIG. 2 can end. According to various examples, the transfer application 116 can send a compliance level-verified notification to a user interface 119 on the first client device 103a, or the recipient client device 103b, or another application, system, or service in the network environment 100.

At block 219, the transfer application 116 of the first client device 103a can be executed to sign the secure files 129 using the private key of the first client device 103a. In some embodiments, the transfer application 116 can sign the secure files 129 based at least in part on a successful verification of the certificate received at block 209 or a successful verification of the compliance levels at block 216 or both. According to various examples, the transfer application 116 can sign the secure files 129 with the private key of the first client device 103a in response to receipt of a send command, or transfer request. The transfer application 116 can sign the secure files 129 which have been identified in a transfer request.

At block 223, the transfer application 116 of the first client device 103a can be executed to encrypt the secure files 129 using the public key of the recipient client device 103b. In some embodiments, the transfer application 116 can encrypt the secure files 129 based at least in part on a successful verification of the certificate received at block 209 or a successful verification of the compliance levels at block 216 or both. According to some embodiments, the transfer application 116 can be executed to encrypt the secure files 129 after the secure files 129 have been signed with the private key of the first client device 103a.

Then, at block 226, the transfer application 116 can be executed to send the encrypted secure files 129 to the recipient client device 103b. In some embodiments, the transfer application 116 can send the secure files 129 to a transfer application 116 on the recipient client device 103b. After block 226, the flowchart of FIG. 2 comes to an end.

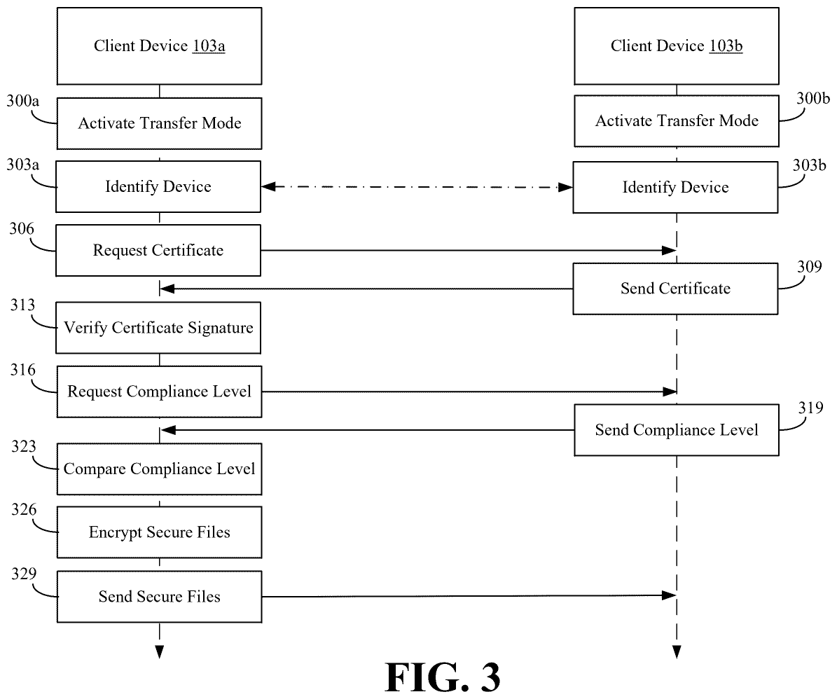

Moving on to FIG. 3, shown is a sequence diagram illustrating one example of the interactions between multiple client devices 103a and 103b according to various embodiments. It is understood that the sequence diagram of FIG. 3 provides merely an example of the many different types of functional arrangements that can be employed to implement the operation of the interactions between the client devices 103a and 103b. As an alternative, the sequence diagram of FIG. 3 can be viewed as depicting an example of elements of a method implemented within the network environment 100 (FIG. 1) according to one or more embodiments.

Beginning with block 300a, the client device 103a can activate a transfer mode. In some embodiments, the client device 103a can activate the transfer mode by turning on a pairing mode, sending a broadcast signal to nearby devices, or other means of searching for a recipient client device 103b. In some embodiments, the client device 103a can activate a transfer mode in response to receiving a user interaction with the user interface 119.

Similarly, at block 300b, the client device 103b can active a transfer mode. In some embodiments, the client device 103b can activate the transfer mode by turning on a pairing mode, receiving a broadcast signal and sending a response signal, or other means of receiving and responding to a search signal from a first client device 103a. In some embodiments, the client device 103b can activate a transfer mode in response to receiving a user interaction with a user interface 119.

At block 303a, the first client device 103a can identify a recipient client device 103b. As discussed in the description of block 200 of FIG. 2, the transfer application 116 of the first client device 103a identify a recipient client device 103b. According to various examples, the first client device 103a can identify a recipient client device 103b in response to the activation of a transfer mode, as discussed at block 300a. In some embodiments, the first client device 103a can send a notification to the user interface 119 of the first client device 103a, the recipient client device 103b, or another application, system, or service in the network environment 100 once a recipient client device 103b has been identified.

At block 303b, the recipient client device 103b can identify the first client device 103a. In some embodiments, the transfer application 116 of the recipient client device 103b identify a first client device 103a. According to various examples, the recipient client device 103b can identify the first client device 103a in response to the activation of a transfer mode, as discussed at block 300b. In some embodiments, the recipient client device 103b can send a notification to the user interface 119 of the recipient client device 103b, the first client device 103a, or another application, system, or service in the network environment 100, once the first client device 103a has been identified.

At block 306, the first client device 103a can request a certificate 126 from the recipient client device 103b. The first client device 103a can request a certificate 126 by sending a certificate request to the transfer application 116 of the recipient client device 103b. In some embodiments, the first client device 103a can request the certificate chain from the recipient client device 103b.

At block 309, the recipient client device 103b can send the certificate 126 to the first client device 103a. In some embodiments, the recipient client device 103b can send the certificate 126 in response to receiving the certificate request at block 306. In some embodiments, the transfer application 116 of the recipient client device 103b can send the certificate chain to the transfer application 116 of the first client device 103a.

Next, at block 313, the first client device 103a can verify the certificate signature of the certificate 126 received at block 309. As discussed in the description of block 209 of FIG. 2, the transfer application 116 of the first client device 103a can verify the certificate signature from the certificate 126 obtained at block 309. The transfer application 116 can determine the signature from the certificate 126 obtained at block 309 and verify the signature of the certificate 126 based at least in part on a root certificate 126 which corresponds to the certificate obtained from the recipient client device 103b. In some embodiments, the first client device 103a can compare the signature of the certificate 126 obtained from the recipient client device 103b to the certificate 126 of the first client device 103a. The first client device 103a can verify that the recipient client device 103b is enrolled with the same enterprise as the first client device 103a based at least in part on the certificate 126. According to some examples, if the certificate signature does not identify a recipient client device 103b enrolled with the same enterprise as the first client device 103a, or the transfer application 116 otherwise fails to verify the certificate signature, the transfer application 116 can end the connection between the first client device 103a and the recipient client device 103b. In these examples, when the connection ends, the sequence diagram of FIG. 3 can end. In some examples, the first client device 103a can verify the certificate signature and thereby, the enrollment status of the recipient client device 103b and proceed to the next block. In some embodiments, if the root certificate corresponds to an enterprise with which the first client device 103a is enrolled, the verification is successful.

At block 316, the first client device 103a can request the compliance level 133 from the recipient client device 103b. In some embodiments, the transfer application 116 of the first client device 103a can send a compliance level request to the transfer application 116 of the recipient client device 103b. The first client device 103a can request the compliance level 133 based at least in part on a successful verification of the enrollment status, and certificate signatures, of the recipient client device 103b.

At block 319, the recipient client device 103b can send the compliance level 133 to the first client device 103a. In some embodiments, the recipient client device 103b can send the compliance level 133 in response to receiving the compliance level request at block 316. In some embodiments, the transfer application 116 of the recipient client device 103b can retrieve the compliance level 133 from the data store 123 on the recipient client device 103b to send to the first client device 103a.

Next, at block 323, the first client device 103a can compare the compliance level 133 received at block 319 to the compliance level 133 of the secure files 129 to be transferred. In some embodiments, the transfer application 116 of the first client device 103a can perform the comparison of the compliance levels 133 as described in the discussion of block 216 of FIG. 2. According to various examples, if the compliance levels 133 of the recipient client device 103b and the secure files 129 match, then the first client device 103a can proceed to the next step. In some examples, where the compliance levels 133 do not match, the first client device 103a can determine if the compliance level 133 of the recipient client device 103b is higher or lower than the compliance level 133 of the secure files 129. In some embodiments, when the compliance level 133 of the recipient client device 103b is higher than that of the secure files 129, the first client device 103a can verify the compliance level and proceed to the next step. In some embodiments, when the compliance level 133 of the recipient client device 103b is lower than the compliance level 133 of the secure files 129, the first client device 103a can stop the transfer and the sequence diagram of FIG. 3 can end.

Moving to block 326, the first client device 103a can encrypt the secure files 129. In some embodiments, the first client device 103a can sign the secure files 129 using the private key of the first client device 103a, and then encrypt the secure files 129 using the public key of the recipient client device 103b. In some embodiments, the transfer application 116 of the first client device 103a can encrypt the secure files 129 using a symmetric key shared between the first client device 103a and the recipient client device 103b. According to various examples, the transfer application 116 of the first client device 103a can encrypts the secure files 129 in response to a send command, or transfer request, which identifies the secure files 129 to be encrypted and transferred. In some examples, multiple encryption levels can be employed by the first client device 103a to encrypt the secure files 129 such that only the recipient client device 103b which has been verified can receive and decrypt the secure files 129.

Next, at block 329, the first client device 103a can send the secure files 129 to the recipient client device 103b. In some embodiments, the transfer application 116 of the first client device 103a can send the secure files 129 to the transfer application 116 of the recipient client device 103b as described in the discussion of block 226 of FIG. 2. According to various examples, the first client device 103a can send the secure files 129 in response to receipt of a user interaction with the user interface 119. The first client device 103a can send the secure files 129 after the secure files 129 have been encrypted at block 326, after the compliance levels 133 have been verified at block 323, after the certificate signatures have been verified at block 313, or in response to success at each of blocks 313, 323, and 326. After block 329, the sequence diagram of FIG. 3 comes to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine-readable instructions stored in the memory that, when executed by the processor, cause the computing device to at least:
identify a recipient device for a secure file transfer;
verify an enrollment status of the recipient device with an enterprise;
verify a compliance level of the recipient device; and
based at least in part on a successful verification of the enrollment status and the compliance level, transfer one or more secure files to the recipient device.

2. The system of claim 1, wherein the machine-readable instructions, when executed, further cause the computing device to at least establish a secure connection between the computing device and the recipient device.

3. The system of claim 1, wherein the machine-readable instructions which, when executed, cause the computing device to verify the enrollment status of the recipient device, further cause the computing device to at least:
obtain a certificate from the recipient device; and
verify a signature of the certificate based upon a root certificate corresponding to the certificate obtained from the recipient device.

4. The system of claim 3, wherein verification of the enrollment status is successful when the root certificate corresponding to the certificate matches the root certificate of the enterprise.

5. The system of claim 1, wherein the machine-readable instructions which, when executed, cause the computing device to verify a compliance level of the recipient device, further cause the computing device to at least:
obtain a security classification of the recipient device; and
compare the security classification of the recipient device to a security classification of the one or more secure files.

6. The system of claim 5, wherein verification of the compliance level is successful when the security classification of the recipient device matches the security classification of the one or more secure files.

7. The system of claim 1, wherein the machine-readable instructions which, when executed, cause the computing device to transfer one or more secure files to the recipient device, further cause the computing device to at least:
sign the one or more secure files using a private key of the computing device;
encrypt the one or more secure files using a public key of the recipient device; and
send the one or more secure files to the recipient device.

8. A method, comprising:
identifying, by a computing device, a recipient device for a secure file transfer;
verifying, by the computing device, an enrollment status of the recipient device with an enterprise;
verifying, by the computing device, a compliance level of the recipient device; and
based at least in part on a successful verification of the enrollment status and the compliance level, transferring, by the computing device, one or more secure files to the recipient device.

9. The method of claim 8, further comprising establishing a secure connection between the computing device and the recipient device.

10. The method of claim 8, wherein verifying the enrollment status of the recipient device further comprises:
obtaining, by the computing device, a certificate from the recipient device; and
verifying, by the computing device, a signature of the certificate based upon a root certificate corresponding to the certificate obtained from the recipient device.

11. The method of claim 10, wherein verification of the enrollment status is successful when the root certificate corresponding to the certificate matches the root certificate of the enterprise.

12. The method of claim 8, wherein verifying a compliance level of the recipient device further comprises:
obtaining, by the computing device, a security classification of the recipient device; and
comparing, by the computing device, the security classification of the recipient device to a security classification of the one or more secure files.

13. The method of claim 12, wherein verification of the compliance level is successful when the security classification of the recipient device matches the security classification of the one or more secure files.

14. The method of claim 8, wherein transferring the one or more secure files further comprises:
signing, by the computing device, the one or more secure files using a private key of the computing device;
encrypting, by the computing device, the one or more secure files using a public key of the recipient device; and
sending, by the computing device, the one or more secure files to the recipient device.

15. A non-transitory, computer-readable medium, comprising machine readable instructions that, when executed by a processor of a computing device, cause the computing device to at least:
identify a recipient device for a secure file transfer;
verify an enrollment status of the recipient device with an enterprise;
verify a compliance level of the recipient device; and
based at least in part on a successful verification of the enrollment status and the compliance level, transfer one or more secure files to the recipient device.

16. The non-transitory, computer-readable medium of claim 15, wherein the machine-readable instructions, when executed, further cause the computing device to at least establish a secure connection between the computing device and the recipient device.

17. The non-transitory, computer-readable medium of claim 15, wherein the machine-readable instructions which, when executed, cause the computing device to verify the enrollment status of the recipient device, further cause the computing device to at least:
obtain a certificate from the recipient device; and
verify a signature of the certificate based upon a root certificate corresponding to the certificate obtained from the recipient device.

18. The non-transitory, computer-readable medium of claim 17, wherein verification of the enrollment status is successful when the root certificate corresponding to the certificate matches the root certificate of the enterprise.

19. The non-transitory, computer-readable medium of claim 15, wherein the machine-readable instructions which, when executed, cause the computing device to verify a compliance level of the recipient device, further cause the computing device to at least:
obtain a security classification of the recipient device;
compare the security classification of the recipient device to a security classification of the one or more secure files; and
determine verification of the compliance level is successful based at least in part on a match between the security classification of the recipient device and the security classification of the one or more secure files.

20. The non-transitory, computer-readable medium of claim 15, wherein the machine-readable instructions which, when executed, cause the computing device to transfer one or more secure files to the recipient device, further cause the computing device to at least:
sign the one or more secure files using a private key of the computing device;
encrypt the one or more secure files using a public key of the recipient device; and
send the one or more secure files to the recipient device.
